(19) United States
(12) Patent Application Publication
(10) Pub. No.: US 2016/0356948 A1
(43) Pub. Date: Dec. 8, 2016

(54) BACKLIGHT MODULE AND CURVED LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventor: Chengwen QUE, Shenzhen, Guangdong (CN)

(73) Assignee: Shenzhen China Star Optoelectronics Technology Co., Ltd., Shenzhen, Guangdong (CN)

(21) Appl. No.: 14/442,717

(22) PCT Filed: Mar. 4, 2015
(86) PCT No.: PCT/CN2015/073613

§ 371 Date: May 13, 2015

(30) Foreign Application Priority Data
Feb. 5, 2015 (CN) 201510061058.1

(51) Int. Cl. F21V 8/00

(52) U.S. Cl. CPC G02B 6/0088; G02B 6/0085; G02B 6/009; G02B 6/0026; G02B 6/0055

(57) ABSTRACT

A backlight module including: a backplane, a curved light guide plate (LGP) and a light source. A heat-dissipating plate is disposed on the backplane and includes a support part fixed on the backplane and an installation part for installing the light source, an angle between the support part and the installation part is α. A fixing bracket of quantum strip is disposed on the heat-dissipating plate and includes a connection part connected to the support part and a main body part between the light source and the curved LGP, the main body part is disposed with communicated accommodating groove, light incident groove and light-emitting groove, an angle between the main body part and the connection part is β, where α=β, the main body part is approximately parallel to a light-incident surface of the curved LGP. A liquid crystal display device also is provided.

### TECHNICAL FIELD

The invention relates to the field of liquid crystal display technology, and particularly to a backlight module of curved crystal display device and a curved liquid crystal display device.

### DESCRIPTION OF RELATED ART

Flat panel display devices have been booming with the evolution of optoelectronic and semiconductor technologies, and in many types of flat panel display devices, liquid crystal display (LCD) devices have become the mainstream of market due to their many superior characteristics such as high space utilization efficiency, low power consumption, radiation-free and low electromagnetic interference.

A liquid crystal display (LCD) device typically includes a liquid crystal display panel and a backlight module (BL). Because the liquid crystal display panel itself does not have the characterization of self-luminous, the backlight module must be disposed below the liquid crystal display panel to provide a surface light source for the liquid crystal display panel, so that the liquid crystal display panel can display images according to the surface light source provided by the backlight module.

In recent years, major manufacturers have successively launched curved liquid display devices. Overall, the curved liquid display devices can provide better viewing experience from a border to another border, while the traditional flat liquid display device has an unsatisfactory display effect at the border of the screen. The surround type arc design of whole screen toward the user of the curved liquid display device can provide wide panoramic image effect, the center and the periphery of the screen both are able to bring same visual enjoyment to the user, and further can reduce the off-axis viewing distortion when viewing at a close distance. In addition, the curved liquid display device could elongate the viewing distance of the user and thereby achieving better viewing experience. In current curved liquid display devices, most of which use an edge-type curved backlight module to provide a display light source for curved liquid display panels.

With the development of society, users have increasingly high requirements for image quality of liquid display devices, in order to improve the color saturation of images, a chrominance of light bars in backlight modules is ameliorated to improve the color saturation of images, and a quantum strip is additionally disposed in a backlight module in the prior art. Quantum dot (QD) technology is a technology making electron bound within a certain range of semiconductor nanomaterial structure, and quantum dots are consisted of ultra-small compound crystals with sizes in the range of 1-100 nm, an application in the field of lighting and display thereof is to change a wavelength of incident light and control wavelengths using crystals with different sizes. As long as the sizes of the crystals can be precisely controlled, color can be precisely controlled, and further can achieve a fairly wide range of luminescence. In the field of liquid crystal display technology, quantum dots have been widely applied, and usually are packaged in a transparent glass tube to form a quantum strip.

FIG. 1 shows a longitudinal sectional view of a conventional quantum strip of the prior art, FIG. 2 shows a transversal sectional view of a conventional quantum strip of the prior art. Referring to FIG. 1, in the longitudinal direction, a quantum strip 10 is divided into an active region 11 located in the central and an inactive region 12 located at both ends. Referring to FIG. 2, the quantum strip 10 usually includes a functional portion 13 located inside and a package portion 14 wrapping the functional portion 13, the functional portion 13 is usually made of a material which is used to constitute quantum dots, the package portion 14 is usually made of a glass material. In a backlight module of a liquid crystal display device, a quantum strip is usually disposed between a backlight source and a light guide plate by a fixing bracket.

However, owing to the light guide plate of edge-type curved backlight module being bent/curved, a fixing bracket is desired to be designed for the quantum strip in the backlight module to improve installation stability of the quantum strip and improve the optical coupling efficiency between the light source and the light guide plate.

### SUMMARY

Accordingly, the invention provides a backlight module, the backlight module includes a backplane, a curved light guide plate disposed on the backplane and a light source disposed at a side of the curved light guide plate. A heat-dissipating plate is disposed on the backplane, the heat-dissipating plate includes a support part and an installation part, the installation part is fixed on the backplane, the installation part is used to install the light source, an intersecting angle between the support part and the installation part is α; a fixing bracket of quantum strip is disposed on the heat-dissipating plate, the fixing bracket of quantum strip includes a connection part and a main body part, the connection part is connected to the support part, the main body part is disposed between the light source and the curved light guide plate, the main body part is disposed with an accommodating groove, a light incident groove and a light-emitting groove which are interconnected/communicated with each other, the accommodating groove is configured for receiving/accommodating the quantum strip, the light incident groove is disposed towards the light source, the light-emitting groove is disposed towards the curved light guide plate, an intersecting angle between the main body part and the connection part is β, where α=β, the main body part is approximately/substantially parallel to a light-incident surface of the curved light guide plate.

In an exemplary embodiment, the connection part is disposed with a through hole, the support part is correspondingly disposed with a threaded hole, the connection part is connected to the support part by a threaded fastener.

In an exemplary embodiment, a material of the fixing bracket of quantum strip is an aluminum alloy.

In an exemplary embodiment, the backlight module further includes a reflective plate, the reflective plate is disposed between the backplane and the curved light guide plate, the reflective plate and the curved light guide plate have a same curved arc shape.

In an exemplary embodiment, the backlight module further includes a middle frame and an optical film set, the middle frame is disposed above the fixing bracket of quantum strip; the optical film set is disposed above the curved light guide plate and at least partially placed on the middle frame; the optical film set and the curved light guide plate have a same curved arc shape.

In an exemplary embodiment, the light source is a LED lamp.

The invention further provides a curved liquid crystal display device. The curved liquid crystal display device includes a curved liquid crystal panel and a backlight module, the curved liquid crystal panel is disposed opposite to the backlight module, the backlight module is configured (i.e., structured and arranged) for providing a display light source to the curved liquid crystal panel to make the curved liquid crystal panel display images, wherein, the backlight module is any one of the aforementioned backlight modules.

### Beneficial Effects

The backlight module provided by the embodiments of the invention is mainly applied in a curved liquid crystal display device with a curved liquid crystal panel, by designing the intersecting angle between the support part and the installation part of the heat-dissipating plate and the intersecting angle between the connection part and the main body part of the fixing bracket of quantum strip, the installation part and the main body part are approximately parallel to the light-incident surface of the light guide plate, so that it makes the light-emitting surface of the quantum strip be approximately parallel to the light-incident surface of the curved light guide plate after the light emitted by the light source passes through the quantum strip, the optical coupling efficiency of the light source and the light guide plate can be improved, and the installation stability of the quantum strip also can be improved.

### BRIEF DESCRIPTION OF THE DRAWINGS

FIG. 1 is a longitudinal sectional view of a conventional quantum strip of the prior art;

FIG. 2 is a transversal sectional view of the conventional quantum strip of the prior art;

FIG. 3 is a structural schematic view of a curved liquid crystal display device according to an embodiment of the invention;

FIG. 4 is a structural schematic view of a backlight module according to an embodiment of the invention; and

FIG. 5 is a structural schematic view of a fixing bracket of quantum strip according to an embodiment of the invention.

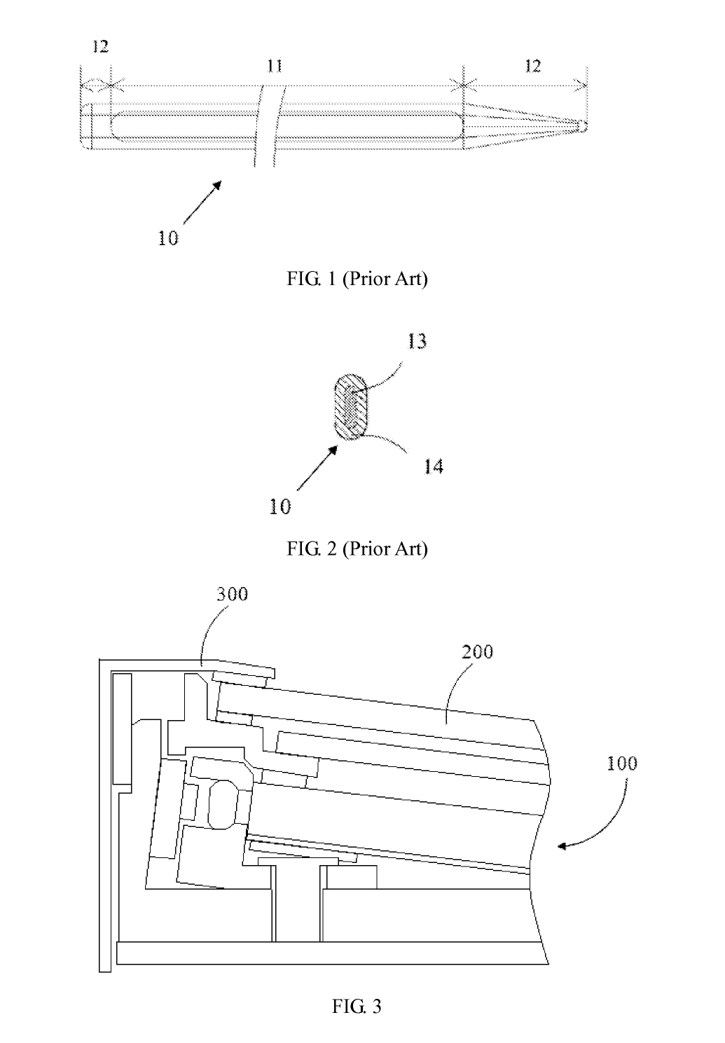

### DETAILED DESCRIPTION OF EMBODIMENTS

In the following, with reference to accompanying drawings and detailed embodiments, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

FIG. 3 is a structural schematic view of a curved liquid crystal display device according to an embodiment of the invention. Referring to FIG. 3, the liquid crystal display device includes a curved liquid crystal panel 200 and a backlight module 100, the curved liquid crystal panel 200 is disposed opposite to the backlight module 100 and they are fixed together by a frame 300. The backlight module 100 provides a display light source to the curved liquid crystal panel 200 to make the curved liquid crystal panel 200 display images.

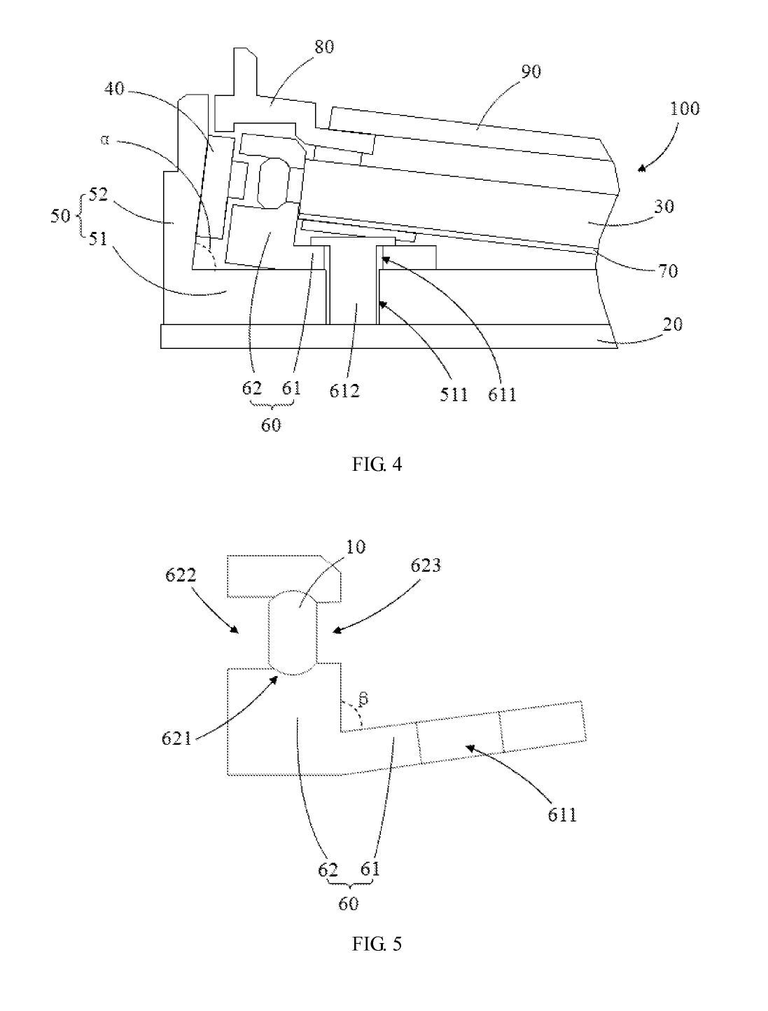

Referring to FIG. 4 and FIG. 5, the backlight module 100 at least includes a backplane 20, a curved light guide plate 30 disposed on the backplane 20, and a light source 40 disposed at a side of the curved light guide plate 30, the light source 40 is disposed/installed on a heat-dissipating plate 50. A quantum strip 10 is disposed between the light source 40 and the curved light guide plate 30, the quantum strip 10 is disposed in a fixing bracket 60 of quantum strip. Furthermore, the backlight module 100 further includes a reflective plate 70, a middle frame 80 and an optical film set 90. The reflective plate 70 is disposed between the backplane 20 and the curved light guide plate 30, the middle frame 80 is disposed above the fixing bracket 60 of quantum strip, the optical film set 90 is disposed above the curved light guide plate 30 and at least partially placed on the middle frame 80, and the curved liquid crystal panel 200 is placed/located on the middle frame 80. The reflective plate 70 and the curved light guide plate 30 have a same curved arc shape, the optical film set 90 and the curved light guide plate 30 have a same curved arc shape.

After a light emitted by the light source 40 passes through the quantum strip 10, a fluorescent material in the quantum strip 10 is excited to emit a light with wider color gamut, then the light is incident into the curved light guide plate 30. The light is emitted out from the top of the curved light guide plate 30, and strikes into the curved liquid crystal panel 200 after passing through the optical film set 90.

Specifically, the heat-dissipating plate 50 includes a support part 51 and an installation part 52, the installation part 52 is used to fix/install the light source 40, an intersecting angle between the support part 51 and the installation part 52 is α. The fixing bracket of quantum strip 60 includes a connection part 61 and a main body part 62, the connection part 61 is connected to the support part 51, the main body part 62 is disposed between the light source 40 and the curved light guide plate 30. Furthermore, the main body part 62 is equipped/disposed with an accommodating groove 621, a light incident groove 622 and a light-emitting groove 623 which are interconnected/communicated with each other, the accommodating groove 621 is used to place/receive the quantum strip 10, the light incident groove 622 is disposed towards the light source 40, the light-emitting groove 623 is disposed towards the curved light guide plate 30. The light is incident into the quantum strip 10 and then emitted out from the light-emitting groove 623. An intersecting angle between the main body part 62 and the connection part 61 is β, and the intersecting angle α is equal to the intersecting angle β. The intersecting angle α and the intersecting angle β are designed according to an intersecting angle between a normal line of the light-incident surface of the curved light guide plate 30 and the backplane, so that the installation part 52 of the heat-dissipating plate 50 and the main body part 62 of the fixing bracket of quantum strip 60 are approximately/substantially parallel to the light-incident surface of the curved light guide plate 30, the optical coupling efficiency of the light source and the light guide plate can be improved.

Specifically, in this embodiment, referring to FIG. 4 and FIG. 5, a through hole 611 is disposed in the connection part 61 of the fixing bracket of quantum strip 60, a threaded hole 511 is correspondingly disposed in the support part 51 of the heat-dissipating plate 50, the connection part 61 is connected on the support part 51 by using a threaded fastener 612.

In a preferred embodiment, a material of the fixing bracket of quantum strip 60 can be an aluminum alloy.

In a preferred embodiment, the light source 40 is a LED lamp.

In summary, the invention is mainly applied in a curved liquid crystal display device with a curved liquid crystal panel, in the backlight module, by designing the intersecting angle between the support part and the installation part of the heat-dissipating plate and the intersecting angle between the connection part and the main body part of the fixing bracket of quantum strip, the installation part and the main body part approximately/substantially are parallel to the light-incident surface of the curved light guide plate, so that it makes the light-emitting surface of the quantum strip be approximately/substantially parallel to the light-incident surface of the curved light guide plate after the light emitted from the light source passes through the quantum strip, the optical coupling efficiency of the light source and the light guide plate is improved, and the installation stability of the quantum strip also is improved.

It is indicated that, in this specification, the relational terminologies such as “first” and “second” only are intended to discriminate an entity or operation from another entity or operation, and not necessarily to require or imply these entities or operations having actual relationships or orders existed therebetween. Moreover, the terminology of “including”, “containing” or variations thereof is meant to encompass non-exclusive inclusion, so that a process, method, article or apparatus including a series of items not only includes listed items but also includes other item(s) not being explicitly listed or inherent item(s) of the process, method, article or apparatus. In the absence of more restrictive conditions, the item limited by the phraseology “including one” does not exclude the existence of additional identical item(s) in the process, method, article or apparatus including the item.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module comprising: a backplane, a curved light guide plate disposed on the backplane and a light source disposed at a side of the curved light guide plate; wherein, the backplane has a heat-dissipating plate disposed thereon, the heat-dissipating plate comprises a support part and an installation part, the installation part is fixed on the backplane, the installation part is configured for installing the light source, an intersecting angle between the support part and the installation part is α; the heat-dissipating plate has a fixing bracket of quantum strip disposed thereon, the fixing bracket of quantum strip comprises a connection part and a main body part, the connection part is connected to the support part, the main body part is disposed between the light source and the curved light guide plate, the main body part is disposed with an accommodating groove, a light incident groove and a light-emitting groove which are communicated with each other, the accommodating groove is configured for accommodating a quantum strip, the light incident groove is disposed towards the light source, the light-emitting groove is disposed towards the curved light guide plate, an intersecting angle between the main body part and the connection part is β, where α=β, the main body part is substantially parallel to a light-incident surface of the curved light guide plate.

2. The backlight module as claimed in claim 1, wherein the connection part is disposed with a through hole, the support part is correspondingly disposed with a threaded hole, the connection part is connected to the support part by a threaded fastener.

3. The backlight module as claimed in claim 1, wherein a material of the fixing bracket of quantum strip is an aluminum alloy.

4. The backlight module as claimed in claim 2, wherein a material of the fixing bracket of quantum strip is an aluminum alloy.

5. The backlight module as claimed in claim 1, wherein the backlight module further comprises a reflective plate, the reflective plate is disposed between the backplane and the curved light guide plate, the reflective plate and the curved light guide plate have a same curved arc shape.

6. The backlight module as claimed in claim 1, wherein the backlight module further comprises a middle frame and an optical film set, the middle frame is disposed above the fixing bracket of quantum strip; the optical film set is disposed above the curved light guide plate and at least partially placed on the middle frame; the optical film set and the curved light guide plate have a same curved arc shape.

7. The backlight module as claimed in claim 5, wherein the backlight module further comprises a middle frame and an optical film set, the middle frame is disposed above the fixing bracket of quantum strip; the optical film set is disposed above the curved light guide plate and at least partially placed on the middle frame; the optical film set and the curved light guide plate have a same curved arc shape.

8. The backlight module as claimed in claim 1, wherein the light source is a LED lamp.

9. A curved liquid crystal display device comprising: a curved liquid crystal panel and a backlight module, the curved liquid crystal panel is disposed opposite to the backlight module, the backlight module is configured for providing a display light source to the curved liquid crystal panel to make the curved liquid crystal panel display an image; wherein the backlight module comprises: a backplane, a curved light guide plate disposed on the backplane and a light source disposed at a side of the curved light guide plate, the backplane has a heat-dissipating plate disposed thereon, the heat-dissipating plate comprises a support part and an installation part, the installation part is fixed on the backplane, the installation part is configured for installing the light source, an intersecting angle between the support part and the installation part is α; the heat-dissipating plate has a fixing bracket of quantum strip disposed thereon, the fixing bracket of quantum strip comprises a connection part and a main body part, the connection part is connected to the support part, the main body part is disposed between the light source and the curved light guide plate, the main body part is disposed with an accommodating groove, a light incident groove and a light-emitting groove which are interconnected with each other, the accommodating groove is configured for receiving a quantum strip, the light incident groove is disposed towards the light source, the light-emitting groove is disposed towards the curved light guide plate, an intersecting angle between the main body part and the connection part is β, where α=β, the main body part is substantially parallel to a light-incident surface of the curved light guide plate.

10. The curved liquid crystal display device as claimed in claim 9, wherein the connection part is disposed with a through hole, the support part is correspondingly disposed with a threaded hole, the connection part is connected to the support part by a threaded fastener.

11. The curved liquid crystal display device as claimed in claim 9, wherein a material of the fixing bracket of quantum strip is an aluminum alloy.

12. The curved liquid crystal display device as claimed in claim 10, wherein a material of the fixing bracket of quantum strip is an aluminum alloy.

13. The curved liquid crystal display device as claimed in claim 9, wherein the backlight module further comprises a reflective plate, the reflective plate is disposed between the backplane and the curved light guide plate, the reflective plate and the curved light guide plate have a same curved arc shape.

14. The curved liquid crystal display device as claimed in claim 9, wherein the backlight module further comprises a middle frame and an optical film set, the middle frame is disposed above the fixing bracket of quantum strip; the optical film set is disposed above the curved light guide plate and at least partially placed on the middle frame; the optical film set and the curved light guide plate have a same curved arc shape.

15. The curved liquid crystal display device as claimed in claim 13, wherein the backlight module further comprises a middle frame and an optical film set, the middle frame is disposed above the fixing bracket of quantum strip; the optical film set is disposed above the curved light guide plate and at least partially placed on the middle frame; the optical film set and the curved light guide plate have a same curved arc shape.

16. The curved liquid crystal display device as claimed in claim 9, wherein the light source is a LED lamp.
